(19) United States
(12) Patent Application Publication
(10) Pub. No.: US 2020/0290257 A1
(43) Pub. Date: Sep. 17, 2020

(54) MOULDING-PARAMETERS PROCESSING METHOD FOR AN INJECTION PRESS

(71) Applicant: INGLASS S.P.A., San Polo Di Piave (IT)

(72) Inventors: Maurizio BAZZO, San Polo Di Piave (IT); Nicola PAVAN, San Polo Di Piave (IT); Riccardo VILLA, San Polo Di Piave (IT)

(21) Appl. No.: 16/767,604

(22) PCT Filed: Nov. 22, 2018
(86) PCT No.: PCT/IB2018/059217

§ 371 Date: May 28, 2020

(30) Foreign Application Priority Data
Nov. 29, 2017 (IT) 102017000137440

(51) Int. Cl. B29C 45/76

(52) U.S. Cl. CPC B29C 45/766; B29C 45/77; B29C 45/7693

(57) ABSTRACT

A method is described for processing moulding parameters (Pᵢ₊₁) for an injection moulding machine (10) obtained by CAE.

The CAE simulation generates simulation results (Aᵢ), first machine parameters (Pᵢ) are generated by electronically processing the simulation results (Aᵢ), second machine parameters (Pᵢ₊₁) are obtained, different from the first ones, from the execution of another moulding process for the same object; and in an electronic database (M) accessible by a user the first and second machine parameters are saved associating them in a common collection.

The invention relates to a method for processing molding parameters for an injection molding press obtained by means of CAE (Computer Aided Engineering). The invention also refers to a method for optimizing molding parameters for an injection molding press obtained through CAE (Computer Aided Engineering).

In general, the definition of the final molding parameters loaded in the various control units of an injection molding press requires a large number of molding tests and a long period of manual setting, since it all depends on the know-how and experience of the operator programming the press.

To limit the preparation period, virtual molding simulations are performed using CAE programs to produce the initial molding parameters. However, CAE programs are not perfect and cannot take into account all the complex phenomena that occur within a mould and that change from mould to mould. E.g. the physical conditions during the actual molding do not coincide with the molding conditions assumed by the CAE software, so in practice the results of the actual molding vary (even significantly) from the results of the virtual molding.

To solve this problem US2002/0188375 presents a method for determining the molding parameters using CAE.

First, temporary molding parameters for the injection press, taken from a standard database or after a generic test injection, are set up. Then, with the press an actual molding of the piece is carried out and a real profile of the pressure variation actually measured during the actual injection phase is acquired. Meanwhile, the CAE system performs virtual molding (simulation) using provisional molding data and obtains a virtual profile. By comparing the virtual and the real profile on a display, an operator manually corrects the parameters so that a part of the profiles coincides, thus obtaining intermediate parameters. The decision about which side to make a match on is crucial and made by the operator. Then, to reduce the drastically undulating trends of some physical variables, virtual modeling is performed again to optimize, for example, the temperature distribution and the pressure distribution. Consequently, the intermediate parameters are still manually corrected to obtain parameters for optimal moulded products.

It is evident that in US2002/0188375 the convergence towards optimized parameters depends only on the experience or ability of the operator, so there is no certainty of result. Furthermore, the choice of the initial parameters is arbitrary and unrelated to the product to be moulded, so the initial parameters are almost always very far from the optimal ones and many iterations are needed for convergence (if ever there is).

It would be very useful to have a method for easily processing and/or comparing the data generated by the CAE simulation and the data collected from actual molding processes.

It would also be very useful to have an optimization method that is more precise, faster and less operator-dependent.

The object of the invention is to provide such a method to overcome one or more of the aforesaid problems. The method is defined in the appended claims, wherein the dependent ones define advantageous variants.

A first aspect of the invention relates to a method for processing molding parameters for an injection molding machine obtained through CAE (ComputerAided Engineering), comprising the steps of

(i) simulating through CAE a moulding process needed to mould an object, wherein the CAE simulation generates (a file of) simulation results,

(ii) generating first machine parameters by electronically processing the simulation results to make them compatible with the data protocol of a control unit of the machine, so that the machine can perform an actual molding process according to the first machine parameters;

(iii) obtaining second machine parameters, different from the first ones, from the execution of another molding process for the same object;

(iv) saving in an electronic database (e.g. a memory or a server) accessible by a user the first and second machine parameters associating them in a common collection.

The simultaneous and ordered presence in the database of the machine parameters allows an operator to find and process them quickly, having available in an orderly manner the evolutions or developments of a molding project/process. The fast and orderly availability of the evolutions or developments of a molding project/process allows to efficiently evaluate which variations in the machine parameters can lead to an improved quality moulded object.

By control unit of the molding machine it is meant here and below any control unit comprised in a machine designed to mould objects by injection of molten material. In particular, the control unit may be

the control unit of the press (i.e. of the members exerting a force on the mold to counter the internal injection pressure), and/or

the control unit dedicated to the injection control (e.g. for the control of a hot runner and/or an injector), and/or

the control unit dedicated to the control of the movement of the mold or of parts of the mold and/or mechanisms external to the mold inherent in—or cooperating with—the molding cycle, and/or

a control unit that remotely sends commands to the components of the machine; and/or

a control unit that sends commands to accessory components of the machine, such as a dryer or a humidifier.

The same applies to the control unit 20 described below.

By software it is meant one or more programs, or sets of instructions, which may be used on a processing system, and/or executed for example by a microprocessor, in order to perform certain actions or activities.

For CAE software it is meant a software application which, by numerical calculation, solves exactly or in approximate form mathematical equations relative to a model of a physical phenomenon. The CAE system—here applied to injection molding—e.g. allows the input of a mathematical model of the physical system to be studied, the numerical calculation on the model and the visualization and analysis of the results.

By machine parameters it is meant the parameters used in the programming of a said control unit with respect to the production cycle of a moulded object, such as for example. the parameters of speed and pressure of the injection unit, or the machine parameters relating to one or each closing and/or opening speed profile of the shutters, or one or each activation sequence of the injectors, or one or each movement sequence of parts of the mold, or one or each movement sequence of external parts—but associated with the molding process. As an example of the last category, we cite mechanical structures for IMC (In-mold Closing) or IMA (In-mold Assembly), both with the aim of making the mold produce e.g. a cap already ready to be mounted on the destination bottle, avoiding a manual or automated closing step of the same.

By processing by means of software it is meant the transformation of data through the application of mathematical formulas or algorithms.

Preferably, said simulation results of the CAE software comprise:

generic machine parameters, i.e. not referred to a particular machine but which generally express a desired adjustment or setting of the machine, such as for example the injection speed profile of the injection unit; and/or

simulated process data, i.e. values of physical quantities related to the molding process, such as for example the pressure or temperature at a certain point of the molded piece or of the mold.

The generic machine parameters are adapted to a particular machine by means of said conversion, in which the generic machine regulations or settings used in the CAE simulation are effectively implemented in the machine, translating them into parameterizations or specific commands of the control unit (each control unit operates with different data protocols and/or structures).

Preferably, the generic machine parameters and/or the simulated process data are also saved in the common collection.

Preferably in said common collection there are saved also real process data, that is values of physical quantities relative to the molding process detected by sensors on board the machine during the actual injection molding process, such as for example the pressure or temperature at a certain point of the molded piece or mold.

Preferably in said common collection the real process data obtained during the molding with the first and/or second machine parameters, are saved.

In a variant, step (ii)

is performed by a software, and/or

occurs with a further step of generating from the simulation results obtained from the CAE simulation software a file readable by a software installed in the control unit. The file may, if necessary, undergo a data conversion process to adapt the data protocol of the CAE simulation software to the data protocol of the software installed in one of the abovementioned control units. The conversion process too is preferably performed by a software.

In a variant, step (iv)

is performed by a software, and/or

occurs with the further step of generating

from data internal to the software installed in the control unit and/or

from real process data detected by the machine,

a file readable by the CAE simulation software. The file can, if necessary, undergo a conversion process to adapt the data protocol of the software installed in the control unit to the CAE simulation software. This conversion process is also preferably performed by software.

In a variant of step (iii) and (iv), said other molding process is performed N times with machine parameters different from the first machine parameters, where N>=2. In each N-th iteration the second machine parameters used may be:

either manually-set machine parameters, or

generated by the following steps of the method:

processing with a software the machine parameters of the (N-1)-th iteration and the machine parameters of the (N-2)-th iteration to generate new machine parameters, and

using said new machine parameters as machine parameters in the N-th iteration of step (iii).

In a variant of step (iii) and (iv), said other molding process is performed with machine parameters different from the first machine parameters, where N >=2. In each N-th iteration the second machine parameters used may be:

either manually-set machine parameters, or

generated by the following steps of the method:

processing with a software the machine parameters of the (N-1)-th iteration, and

using said new machine parameters as machine parameters in the N-th iteration of step (iii).

It is possible to also optimize the machine parameters thanks to the further steps of the method of

(v) processing the data contained in the common collection with a software and

(vi) modifying the machine parameters calculated with a subsequent CAE simulation as a function of the processing produced by said software in step (v).

In particular, it is possible to obtain optimized machine parameters by modifying the CAE software internally or modifying the data that it generates as a function of the machine parameters generated by the previous iteration or as a function of all the previous iterations. The method then makes it possible to construct said database of parameters and then exploit the overall information thereof to modify the parameters of the next iteration.

The iterations e.g. may take place always producing the same object, in order to converge more quickly to a set of optimized parameters (each time the specific knowledge gained until the second-last iteration is fully exploited).

After various iterations of steps (i) to (vi), step (vi) will be able to generate machine parameters which, used for example in the moulding machine, will lead to a less faulty or higher quality object.

If necessary at each N-th iteration said conversion is performed to obtain the machine parameters adapted to the control unit.

In a variant, step (v) occurs through a software. This software may e.g. be the software installed in the control unit, or the CAE simulation software or a third software distinct from the first two. Said software has, and/or has access to, the first and second machine parameters, or in general to all the files or data present in said common collection and/or related to one or each iteration.

In a variant, step (vi) takes place through a software, e.g. through said third software or through the CAE simulation software. The execution of one or each step (i)-(vi) through a software allows automation, speed and repeatability.

If step (vi) takes place through said third software, such third software may communicate with the CAE simulation software in various ways, e.g. via a data exchange file or in real time by sharing a common memory area or virtual environment, such as the said database.

The advantage of using a third software is to avoid modifying the CAE simulation software, which is usually a complex and very specialized program.

In an advantageous variant, the third software may be configured to learn and/or modify its output data, which are input to the CAE simulation software, to optimize the data then generated through simulation by the CAE simulation software. Therefore it is not necessary to alter the functioning of the CAE simulation software (a complex operation, which could also ruin its computational stability). The result of the calculation algorithms of the CAE simulation software can be corrected by modifying the input data brought to the CAE software. In essence, said third software applies a corrective pre-processing to the data input to the CAE software.

In a different advantageous variant, the third software is configured to modify the data generated at the output of the CAE simulation software, to optimize the data generated through simulation by the CAE software. Thus, even this way it is not necessary to alter the operation of the CAE simulation software, of which the result of the calculation algorithms is corrected by modifying the output data (said simulation results). In essence, said third software applies a corrective post-processing to said simulation results.

In a different advantageous variant, the third software is configured to modify a conversion software which performs said conversion between the simulation results and the machine parameters to be loaded in the control unit. Through the modification of the conversion software, which for example is carried out by modifying parameters or variables inside the conversion software, the machine parameters to be loaded in the control unit can be optimized.

E.g. if A₁ is a simulation result that is converted into a machine parameter P₁ by an algorithm in the conversion software via the function

P₁=k·f(A₁);

the third software may be configured to modify the coefficient k and/or the function f (·).

In general, the conversion software may be updated according to the algorithm:

kⱼ=f(A₀, A₁, . . . , A_{n,}B₀, B₁, . . . , B_{z})

Pᵢ=f′(k₀, k₁, . . . , k_{j,}A₀, A₁, . . . , Aₙ)

where:

Pᵢ=i-th machine parameter output by the conversion software,

k₀, k₁, . . . , k_{j,}=correction parameters,

A₀, A₁, . . . , Aₙ=simulation results transferred from the CAE simulator;

B₀, B₁, . . . , B_{z}=actual process data.

An exemplary formula for updating the CAE simulation results, is

qⱼ=g(A₀, A₁, . . . , A_{n,}B₀, B₁, . . . , B_{z})

Tᵢ=g′(q₀, q₁, . . . , q_{j,}A₀, A₁, . . . , Aₙ)

where:

Tᵢ=i-th parameter in the CAE simulation results,

q₀, q₁, . . . , q_{j,}=correction parameters,

A₀, A₁, . . . , Aₙ=simulation results transferred from the CAE simulator;

B₀, B₁, . . . , B_{z} actual process data.

Another advantage is that the third software may comprise artificial intelligence algorithms or neural networks to specifically learn gradually and improve the quality of the data entered as input to the CAE simulation software or of the corrective data applied to the CAE software simulation results.

The third software may be an integrated module or part of/in the CAE software or a separate software, distinct from the CAE software, from which it receives and to which it sends data. As a separate software, distinct from the CAE software, the third software may be e.g. an integrated module or part of the software of an aforementioned control unit or a software running on a device or computer other than the one executing the CAE software and other than the one operating control unit.

If step (vi) occurs through the CAE simulation software, it can receive the processing of the first and second machine parameters in various ways, e.g. through an ad hoc module or a data-entry user interface.

In particular, the third software has such instructions that the data saved in the common collection are used as arguments of mathematical functions or algorithms to generate data to be given as input or output to the CAE software.

Another aspect of the invention relates to a method comprising the steps of

(I) simulating through CAE a moulding process needed to mould an object, where the CAE simulation generates (a file of) simulation results,

(II) generating first machine parameters by adapting the simulation results to make them compatible with the data protocol of the machine's control unit, so that the machine can perform an effective molding process according to said first machine parameters;

(III) obtaining second machine parameters, different from the first ones, from the execution of another molding process for the same object;

(IV) processing the first and second machine parameters with a software,

(V) modifying the machine parameters calculated with a subsequent CAE simulation as a function of the processing produced by said software.

Preferably a step (VI) envisages repeating the steps (III)÷(V) where in step (III) the machine parameters obtained in the previous step (VI) are used.

For one or each step (I) the variants defined for step (i) apply.

For one or each step (II) the variants defined for step (ii) apply.

For one or each step (III) the variants defined for step (iii) apply.

For one or each step (IV) the variants defined for step (v) apply.

For one or each step (VI) the variants defined for step (vi) apply.

In a variant, the second machine parameters are entered manually in the control unit by an operator.

In a variant, the simulation software is loaded and/or executed in any control unit of the machine or press.

In a variant, the parameters returned by the injection press or injection machine comprise not only said machine parameters and/or the said process data monitored by the sensors but also the numerical values generated by auxiliary members not strictly necessary for the injection process itself, such as for example, direct or indirect measuring and/or control devices placed downstream the process.

Another aspect of the invention relates to a software with the characteristics defined here for the third software.

Another aspect of the invention relates to a software with the features defined here for the CAE simulation software.

Another aspect of the invention relates to a software with the characteristics defined here for the software executed in the control unit.

Another aspect of the invention relates to a software and/or a database with the characteristics defined here for said electronic database.

It should be noted that all the above defined variants are object of the invention whether considered alone or in combination with each other.

The advantages of the invention will be even clearer from the following description of a preferred method, in which reference is made to the attached drawing in which

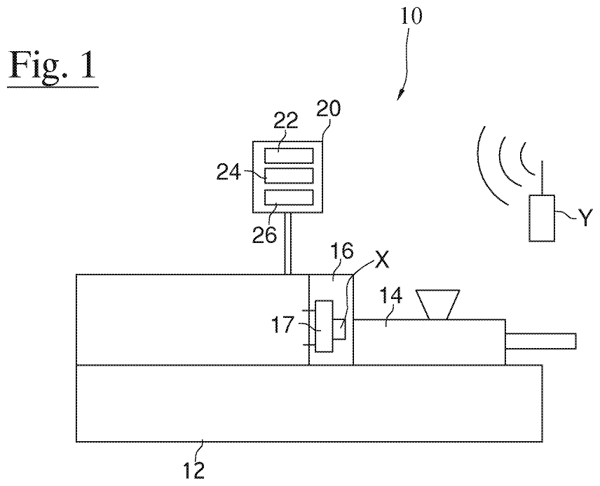

FIG. 1 shows a schematic view of a press;

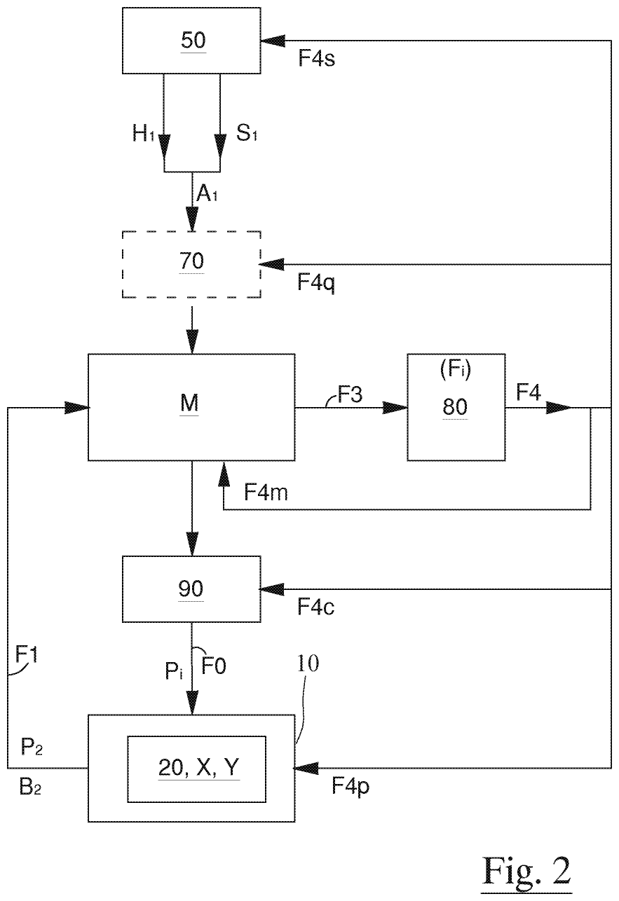

FIG. 2 shows a block scheme.

In the figures: equal numerical references indicate equal elements, and arrows symbolize a transfer of data and/or data itself (where indicated).

The method is applied to an injection molding machine 10. The machine 10 generally comprises e.g. an injection device 14, arranged on a base 12 and provided with a mold 16 with one or more hot runners 17.

A control unit 20, equipped with intelligence, drives various members of the molding machine during the molding steps, and comprises e.g. a display 22 and an operating panel 24 (e.g. a keyboard or touch screen). The control unit 20 is e.g. connected—in a known way—to actuators (not shown) to move parts of the mold and injectors, and/or to sensors for detecting the state of the actuators and the mold.

The control unit 20 also comprises a computer or microprocessor 26, connected to the panel 24.

The control unit 20 can perform data exchange, that is bidirectional data communications, with the outside of the machine 10.

Note that the control unit 20 could also refer to

a control unit designed to control the actuators for moving parts of the mold and/or

an control unit X designed to control the injectors and/or the hot runner 17; and/or

a control unit Y located at a remote place that sends commands, e.g. via wireless means, to the machine 10.

FIG. 2 shows in a block diagram preferred steps of the method.

50 indicates a software or CAE environment in which an operator can model an injection molding process and perform a simulation to virtually study the outcome, i.e. the moulded product.

In the following, the subscript i, i>=1, generally indicates the i-th iteration, if there are multiple iterations.

A first step of the method involves modeling a process of injection molding and running a simulation with the software 50, in order to generate simulation results A₁.

Preferably, the simulation results at the first iteration A₁ comprise generic machine parameters H₁ (as defined above) and/or simulated process data S₁, as defined above.

A second step of the method involves extracting from the CAE environment 50 the simulation results A₁ and inserting them into a memory or electronic database M, accessible by a user, such as a server.

Then, dedicated machine parameters P₁ (arrow F0) are generated from the simulation results A₁.

This step of the method may be performed by a software, indicated with the block 90, which fetches data from memory M and transfers them as input to the control unit 20 as machine parameters to be used. In the block 90 a format conversion may take place, to adapt the parameters to the control unit 20 if the protocol is different. For this purpose, preferably the block 90 generates a data file containing machine parameters P₁, for facilitating the circulation (e.g. via email) and/or the storage.

The software of block 90 may reside in the memory M, in the control unit 20 or elsewhere remotely.

A third step of the method comprises molding in the machine 10 with the parameters P₁ coming from block 90. It is expected that this molding is not optimal, so, as a next step, by varying, e.g. manually, the machine parameters entered earlier new machine parameters are obtained and with them another molding is performed in the machine 10. This step, which can be repeated several times until reaching a moulded product of better quality or desired features, generates at least another set of machine parameters P₂, or various sets P₂, P₃, P₄, etc., it depends on the number of repetitions.

A further step of the method involves exporting (arrow F1) from the control unit 20 the data used and/or generated during one or the last iteration. This data may be the machine parameters P₂ (or Pᵢ₊₁) used during one or the last iteration and/or the actual process data Bᵢ related to one or the last iteration (see definition above).

The machine parameters P₂ (or Pᵢ₊₁) are exported preferably via a data file that contains them, to facilitate their circulation (e.g. via email) and/or their memorization. In the example, the parameters P₂ are exported to the memory M.

Another step of the method involves exporting (arrow F1) from the machine 10, together with the data Pᵢ, the actual process data Bᵢ and importing them e.g. in the memory M.

Then a software in a block 80 processes the data present in the memory M, e.g. H₁, P₂ ( . . . Pᵢ₊₁) and/or S₁, B₂ ( . . . Bᵢ₊₁). The software of the block 80 resides preferably in the memory M, or it can reside in the control unit 20 or elsewhere remotely.

The data transfer to the input of software 80 (arrow F3) may, for example, take place by migrating a file containing the data and generated respectively by the control unit 20 and/or by the software 50. Almost certainly a data conversion is necessary to adapt the data protocol between the software 80 and the control unit 20 and the software 50. Preferably the conversion is performed by the software 80, thereby avoiding to modify pre-existing systems.

The 80 software processes the input data F3 and generates a data output F4.

In this case too a data conversion may be necessary for adapting the data protocol between software 80 and e.g. the software 50. Preferably the conversion is performed by the software 80, thereby avoiding to modify the software 50.

The data output F4 is the product e.g. of intelligent algorithms that gradually learn from the differences between the data H₁, P₂, Pᵢ and/or S₁, B₂, Bᵢ how to generate the data F4 so that a subsequent software simulation 50 generates parameters for the control unit 20 capable of leading to a more accurate moulded product. In particular, the data output F4 is generated as a function of the differences between the data generated during an iteration by the simulator 50 to the molding in the machine. For this purpose, preferably the software 80 is associated with the memory or database M, in which there are saved

the data Pᵢ as the control unit 20 uses them, and/or

the results Aᵢ of the processing performed by the software 50, and/or

the actual process data Bᵢ detected by the sensors of the machine 10, and/or

the results Fᵢ of the i processing operations performed by the software 80 itself.

Preferably all the aforesaid data are saved in the database M, to improve the corrective and optimizing capacity of the software 80.

In the database M, a historical archive is thus created which contains data related to subsequent developments and improvements for the object's molding process.

As it can be seen, the system of FIG. 2 altogether can allow the software 50 to generate more realistic simulations thanks to the contribution of the output F4 processed by the software 80. In particular, the software 80 includes algorithms and/or mathematical functions that have as argument e.g. the data H₁, P₂, Pᵢ and/or H₁, B₂, Bᵢ and/or Fᵢ, and give as output optimized data or correction data.

In particular, the output F4 of the software 80 can be used to

pass to the software 50 optimized parameters (arrow F4s) on which then the software 50 calculates a new simulation giving optimized results Aᵢ₊₁; and/or

generate correction parameters applied in cascade manner by an optional software module 70 to the simulation results Aᵢ₊₁ (arrow F4q), so as to optimize—modifying them—the parameters Aᵢ₊₁ without altering the operation of software 50;

generate parameters Pᵢ₊₁ to send them directly to the control unit 20 (arrow F4p) to perform a molding with the machine 10; and/or

enlarge the database M to make up-to-date data Fᵢ (arrow F4m) available; and/or

pass data to the conversion software 90 (arrow F4c) to generate an optimized output F0 with new parameters Pᵢ₊₁. Data in the F4c stream may for example modify mathematical functions and/or conversion coefficients used within the software 90 to generate the output F0 from the data in the database M.

The software 80 may be implemented in many ways. E.g. it can work to integrate the functions of the software 90, or the software 80 may coincide with or be part of the software 90. Or, or even, the software 80 may be an integrated module or part of/in the software 50 or a separate software, distinct from the software 50, from which it receives and to which it sends data. As separate software, distinct from the software 50, the software 80 may be e.g. an integrated module or part of/in the software of the control unit 20 or a software that runs on a device or computer other than the one running the CAE software and other than the control unit 20.

In particular, the software 80 may apply a mathematical function or algorithms to the data F3 to obtain data Fᵢ, especially by exploiting the knowledge or the history of the data accumulated in the memory M.

Note that the database or memory M, intended as a permanent storage of historical data, could also be absent. A case is e.g. the one in which the system of FIG. 2 functions with multiple iterations on parameters Aᵢ generated in real time to optimize “on the fly” the parameters PI but does not save the results.

Note that each data stream F4s, F4q, F4m, F4c or F4p creates a feedback ring that originates in the data Aᵢ and/or the data F0 (or P₂ and B₂) and, through the software 80, arrives to new optimized data Aᵢ₊₁ and/or data Pᵢ₊₁ (or Pᵢ₊₁ and Bᵢ₊₁).

1. Method for processing moulding parameters (Pᵢ₊₁) for an injection moulding machine (10) obtained by CAE comprising the steps of
(i) simulating through CAE a moulding process needed to mould an object, wherein the CAE simulation generates simulation results (Aᵢ),
(ii) generating first machine parameters (Pᵢ) by electronically processing the simulation results (Aᵢ) to make them compatible with the data protocol of a control unit (20) of the machine, so that the machine can perform an actual moulding process according to the first machine parameters;
(iii) obtaining second machine parameters (Pᵢ₊₁), different from the first ones, from the execution of another moulding process for the same object;
(iv) saving in an electronic database (M) accessible by a user the first and second machine parameters associating them in a common collection.

2. Method according to claim 1, wherein in said common collection generic machine parameters and/or process simulated data are saved too.

3. Method according to claim 1, wherein in said collection real process data are saved, that is values of physical quantities relative to the moulding process detected by sensors on board the machine during an actual injection moulding process.

4. Method according to claim1, wherein the real process data obtained during the moulding with the first and/or second machine parameters are saved in said common collection.

5. Method according to claim 1, wherein step (ii) is performed by a software.

6. Method according to claim 1, wherein step (ii) takes place with the further step of generating from the simulation results obtained by the simulation software CAE a file readable by a software installed in the control unit, wherein said file undergoes a data conversion process to adapt the data protocol of the CAE simulation software to the data protocol of the software installed in the control unit, the conversion process being performed by a software.

7. Method according to claim 1, wherein
said other moulding process is performed N times with machine parameters different from the first machine parameters, where N>=2,
in each N-th iteration the used second machine parameters being machine parameters generated by the following steps:
processing with a software the machine parameters of the (N-1)-th iteration and the machine parameters of the (N-2)-th iteration to generate new machine parameters, and
using said new machine parameters as machine parameters in the N-th iteration of step (iii).

8. Method according to claim 1, with the further steps of
(v) processing the data contained in the common collection with a software,
(vi) modifying the machine parameters calculated with a subsequent CAE simulation as a function of the processing produced by said software in step (v), to obtain optimized machine parameters.

9. Method according to claim 8, wherein optimized machine parameters are obtained by internally modifying the CAE software.

10. Method according to claim 8, wherein optimized parameters are obtained by modifying the data that the CAE software generates.

11. Method according to claim 8, wherein a conversion software, which performs said conversion between the simulation results and the machine parameters to be loaded in the control unit, is modified to optimize the machine parameters.

12. Method according to claim 8, wherein step (v) is carried out through a software.

13. (canceled)
